(19) United States
(12) Patent Application Publication
(10) Pub. No.: US 2016/0008975 A1
(43) Pub. Date: Jan. 14, 2016

(54) RAILROAD MANUALLY ADJUSTABLE SAFETY HANDBRAKE WHEEL UTILITY TOOL ASSEMBLY

(71) Applicant: Chadwick Steven Smith, Roanoke, VA (US)

(72) Inventor: Chadwick Steven Smith, Roanoke, VA (US)

(21) Appl. No.: 13/560,999

(22) Filed: Jul. 28, 2012

Related U.S. Application Data
(60) Provisional application No. 61/669,659, filed on Jul. 9, 2012.

(51) Int. Cl. B25J 1/04; B25G 1/04; B61H 13/02

(52) U.S. Cl. CPC B25J 1/04; B61H 13/02; B25G 1/04

(57) ABSTRACT

Disclosed is a utility tool assembly for use with a handbrake wheel found on most railroad cars and locomotives. The handbrake utility tool assembly includes a dual directional hook head and a slot formed within the head for engaging the air brake retainer valve. The handbrake tool in a further embodiment includes a telescoping handle with a quick connect/disconnect handle assembly for engaging a locking mechanism as the inner handle is extended. The tool includes an anti-flagging or anti rotation locking mechanism so that the tool's head does not rotate uncontrollably.

### CROSS-REFERENCE TO RELATED APPLICATION

This application claims priority to U.S. Provisional Application Ser. No. 61/669,659, filed Jul. 9, 2012, the contents of which are hereby incorporated in their entirety.

### TECHNICAL FIELD

The present invention relates to a utility tool assembly for use with a railroad car and/or locomotive and in greater detail the tool provides a dual directional hook head having a slot formed within for engaging the air brake retainer valve.

### BACKGROUND

Railroad handbrake utility tools are particularly adapted for use with railroad cars and locomotives, most of which have a brake wheel mounted on one end for manually setting and releasing the handbrake of each individual unit or car. The brake wheel is typically mounted so that it is above the head of a crewman walking trackside and perpendicular to the ground, or located inside the potentially hazardous zone between two connected and coupled railroad cars in tandem.

Rules require that a section or cut of cars must be safely secured and locked to prevent any/all premature movement with enough of the cars having the handbrakes engaged in order to avoid risk of a rollaway. While a cut of cars at a rail yard may be adequately secured by having roughly less than 5 percent of the handbrakes applied, in the coal fields the requirement might be as high as sixty to seventy percent of the handbrakes need to be applied.

As just one example of setting the handbrake wheels on the many variations found on current railroad cars, in order to properly set and release such handbrakes, a crewman must approach and or mount the car using the existing iron handholds, (railcar apparatus), ascend a ladder on the side of the car, step to a ladder at the end of the car so that he is then between connected/adjacent cars, place one foot on the brake platform, grasp a rung of the end ladder with one hand and then operate the handbrake wheel with the free hand. After setting or releasing the handbrake, the crewman must then step back to the end ladder, step to the side ladder, descend the side ladder and then dismount from the car. This operation is difficult and strenuous when performed in daylight and comfortable weather conditions. The operation is highly dangerous and hazardous during the night in the worst of adverse weather conditions.

A common long handled hooked utility tool, commonly referred to as a brake stick, is used to lock and unlock, tighten and un-tighten, set and release, or secure and unsecure the railroad car and locomotive safety handbrake wheel. The brake stick operator is required to physically stand either on the railroad vehicle itself, stand between the connected cars, or stand nearby the car or locomotive on potentially unstable ground surface material, (snow, ice, wet loose track ballast, etc), found in and around the railroad vehicle and tracks during any time of day or year in any adverse weather condition.

Locking and unlocking, tightening and un-tightening, setting; and releasing or securing and un-securing the railroad car and locomotive handbrake wheel are the two most critical operational functions that current handbrake tools perform.

The quality and integrity of the handbrake utility tool assembly components and the locking operation and adjustment process are paramount in order to prevent potential equipment failures creating serious safety situations in which the handbrake stick operator could very well be exposed during the middle of the night in the worse possible weather.

All current brake stick or utility tool designs incorporate a single directional hook which is susceptible to potential snapping, breaking and twisting failure of this hook due to repeatedly sudden hard impacts or excessive jolting, hitting, pulling, pushing or twisting force being manually applied to the handbrake wheel to either lock or unlock it. All current single directional brake stick hooks are of a constant material thickness over the entire surface offering only a limited design strength, integrity and resistance to the potential failures.

All current commercially available brake stick tools are flawed with the undesirable characteristic of uncontrollable rotation of the operating end of the brake stick commonly referred to as “flagging”. If the working end, (the head or the hook), of the brake stick is allowed to freely rotate during the process of setting or releasing the handbrake wheel, the frustration of the tool operator is acerbated by the extended amount of prolonged time spent in securing the handbrake wheels on the car or locomotive.

Additionally, one of the available current handbrake tool assemblies is especially difficult to operate during the manual adjustment of locking of the internal collet fingers into position against one of the regularly spaced angular grooves located on the brake stick adjustment rod or tube. This particular current commercially available tool comes with discrete instructions on how to manually lock the brake stick tube into position by determining the proper position by “listening and feeling” for the mating groove moving against the internal collet fingers, compounding this extremely difficult operation, especially in adverse weather conditions.

Operational failure can occur at any unsuspecting time during which the handbrake stick operator may be physically gripping or hanging onto one of the handholds placed on the end or the side of the railroad car itself. Injury may also occur when the handbrake stick operator is standing on unstable ground conditions during the day or throughout the night, (on snow, ice, loose wet track ballast, etc), near or around the railroad car and tracks. If a failure occurs in either of these situations, the brake stick operator could find themselves in a serious safety predicament that could possible result in significant bodily harm.

Thus, what is needed is a more reliable and safe brake stick design to prevent common on the job injuries, such as strained back and leg muscles, suffered by railroad workings manually setting the handbrake wheels.

### SUMMARY

The present invention includes a utility tool assembly for use with a handbrake wheel found on most railroad cars and locomotives. The handbrake utility tool assembly includes a dual directional hook head and a slot formed within the head for engaging the air brake retainer valve. The handbrake utility tool assembly also includes a telescoping handle, which includes a quick disconnect handle assembly for engaging a locking mechanism when the inner handle is extended. Furthermore, the handbrake utility tool assembly includes an anti-flagging or anti rotation locking mechanism so that the tool's head does not rotate uncontrollably.

In greater detail, the handbrake utility tool for use with railroad car's handbrake wheel comprises an elongated handle having a longitudinal axis and a first and second end. The tool also includes a rigid head attached to the first end of the handle. The head includes opposed first and second hooked portions extending laterally from the handle. The hooked portions include each an outer edge head spaced laterally away from the longitudinal axis of the handle. A plurality of concave sections extends laterally from the handle to the outer surface and includes a flat portion substantially perpendicular to the longitudinal axis of the handle. The tool also includes a multiple width slot with chamfered edges formed within the head itself having a longitudinal axis substantially aligned with the longitudinal axis of the handle.

Additionally, the longitudinal axis of the slot includes opposed first and second portions wherein one of the portions is purposely designed to be larger than the other. The larger slot portion with chamfered edges, allow an air brake retainer valve arm or extension to enter more easily.

Furthermore, the outer edge head portions each include a raised rib portion for reinforcing the outer edge portions. Also, the rigid head includes a raised rib portion extending laterally to the longitudinal axis of the handle.

In a further embodiment the elongated handle further includes a telescoping assembly whereby the longitudinal axis of the handle can be extended. The telescoping assembly includes an inner handle section and an outer handle section operatively aligned with the inner handle section.

The inner handle section includes a series of semi-circular grooves extending inward from the outer surface at predetermined locations spaced along the length of the inner handle section. The grooves define predetermined locking positions of the inner handle section relative to the outer handle section. The outer handle includes a quick connect/disconnect locking handle assembly for engaging the grooves defining the predetermined locking positions.

The quick connect/disconnect locking handle mechanism provides an adjustment tool handle that is both a self-locking and anti-rotational design improvement both of which are automatically employed without the operator's knowledge or inspection. The quick connect/disconnect locking handle mechanism quickly, automatically and securely locks the tool at any of the significantly increased number of desired operating lengths without the operator having to manually inspect for a secure locked handle. Also in the quick connect/disconnect locking handle mechanism the outer handle section includes an outer surface having a machined knurled pattern. The knurled pattern provides an easy-to-grip operation for pulling the handle towards an operator when setting the inner handle section to the desired length.

### DRAWINGS

In the drawings:

FIG. 1 depicts an embodiment of the present tool for use with railroad cars and locomotives depicting the rigid head attached to the first end of the telescoping handle portion and the opposed first and second hooked portions of the rigid head extending laterally from the handle and the hooked portions including each an outer edge surface spaced laterally away from the longitudinal axis of the handle. The figure further depicts a plurality of concave sections extending laterally from the handle to the outer edge surface, each of the concave sections including a flat portion substantially perpendicular to the longitudinal axis of the handle and the slot formed within the head having a longitudinal axis substantially aligned with the longitudinal axis of the handle;

FIG. 2 illustrates an embodiment of the quick connect/disconnect locking handle mechanism of the present tool for use with railroad cars and locomotives showing the locked position of the locking mechanism;

FIG. 3 depicts an embodiment of the quick connect/disconnect locking handle mechanism of the present tool for use with railroad cars and locomotives showing the unlocked position of the locking mechanism; and

FIG. 4 illustrates an embodiment of the present tool for use with railroad cars and locomotives wherein the telescoping assembly includes an inner handle section and an outer handle section operatively aligned with the inner handle section. The inner handle section includes a series of grooves extending inward from the outer surface at predetermined locations spaced along the length of the inner handle. The outer handle further including a quick connect/disconnect locking handle assembly for engaging the grooves defining the predetermined locking positions.

### DETAILED DESCRIPTION

Disclosed is a tool assembly for use with a handbrake wheel found on most railroad cars. The handbrake utility tool assembly includes a dual directional hook head for engaging the handbrake wheel and a slot formed within the head for engaging the air brake retainer valve. The handbrake tool in a further embodiment includes a telescoping handle. The telescoping handle portion includes a quick connect/disconnect assembly for engaging or disengaging an internal locking mechanism as the handle is extended or contracted. Furthermore, this utility tool includes an anti-flagging or anti rotation locking mechanism so that the tool's head does not rotate uncontrollably.

In greater detail, the tool for use with railroad cars and locomotives comprises an elongated handle having a longitudinal axis and a first and second end. The first end is attached to the rigid head which engages the handbrake wheel. The handle and rigid head may be formed from most any metal or material of like strength and may be comprised of the same material or not. Additionally, it is contemplated the handle and rigid head may be integral with each other or formed separately depending on the manufacturing and/or the assembly process employed in the attachment of the rigid head to the handle.

The rigid head may be formed from a forging or casting process or otherwise machined. The rigid head essentially includes two hooked portions. As presently depicted the hooked portions appear in an “ax head” configuration, however such illustration is made by example and not by limitation and the tool is not limited to any one configuration. The outer edges of the hook portions are illustrated as “ax heads” but of course can take on any form within the bounds of the claims herein.

The concave section(s) extends laterally from the handle to the outer edge surface and extends above and below the rigid head perpendicular to the handle's longitudinal axis. The concave sections also include a flat portion or substantially flat portion on a plane perpendicular to the longitudinal axis of the handle. The term “substantially flat” includes angles having a measured angle of 25° and below formed by the angle at the juncture of the plane of the flat portion and the longitudinal axis of the handle.

A slot is also formed within the rigid head having a longitudinal axis substantially aligned with the longitudinal axis of the handle. The term “substantially aligned” include alignments out of parallel with the longitudinal axis having a measured angle of 25° and below formed by the angle by a plane intersecting the longitudinal axis of the handle.

The opposed first and second portions of the slot are not equal in dimension in the embodiment of the present tool. The larger wider first portion resides closer to the first end of the handle such that the air brake retainer valve handle, arm or protrusion is first engaged by the larger wider first section which guides the retainer valve arm into the smaller narrower second portion to physically and securely contact the retainer valve handle to the tool.

Furthermore, embodiments include various reinforcements of the rigid head. For example the outer edge head portions may include a raised rib portion for reinforcing the outer edge portions. Also, the rigid head may include a raised rib portion extending laterally to the longitudinal axis of the handle.

A further embodiment of the tool includes an elongated handle with a telescoping assembly whereby the longitudinal axis of the handle can be extended. The telescoping assembly includes an inner handle section and an outer handle section operatively aligned with the inner handle section. It is contemplated that more than two sections can be used in cooperation as known in the formation of telescoping handles or rods.

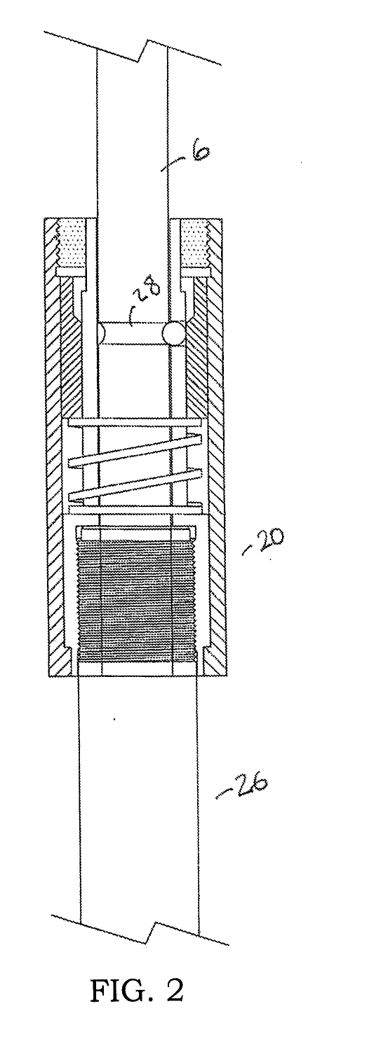

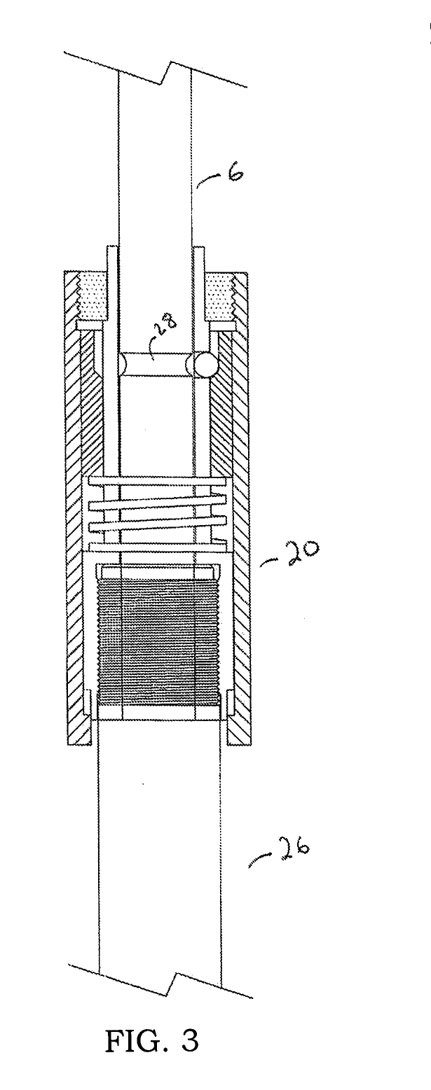

In the formation of the quick connect/disconnect locking mechanism of the telescoping handle the inner handle section includes a series or plurality of semi-circular grooves extending inward from the outer surface at predetermined locations spaced along the length of the inner handle section. The semi-circular grooves define predetermined locking positions of the inner handle section relative to the outer handle section. The outer handle includes a quick connect/disconnect locking handle assembly for engaging the grooves defining the predetermined locking positions. While a quick connect/disconnect locking handle assembly is illustrated in FIGS. 2 and 3 it is contemplated that other known assemblies may be used. Also in the quick connect/disconnect locking handle mechanism the outer handle section includes an outer surface having a knurled pattern. The knurled pattern provides an easy-to-grip operation for pulling the handle towards an operator when setting the inner handle section to the desired length.

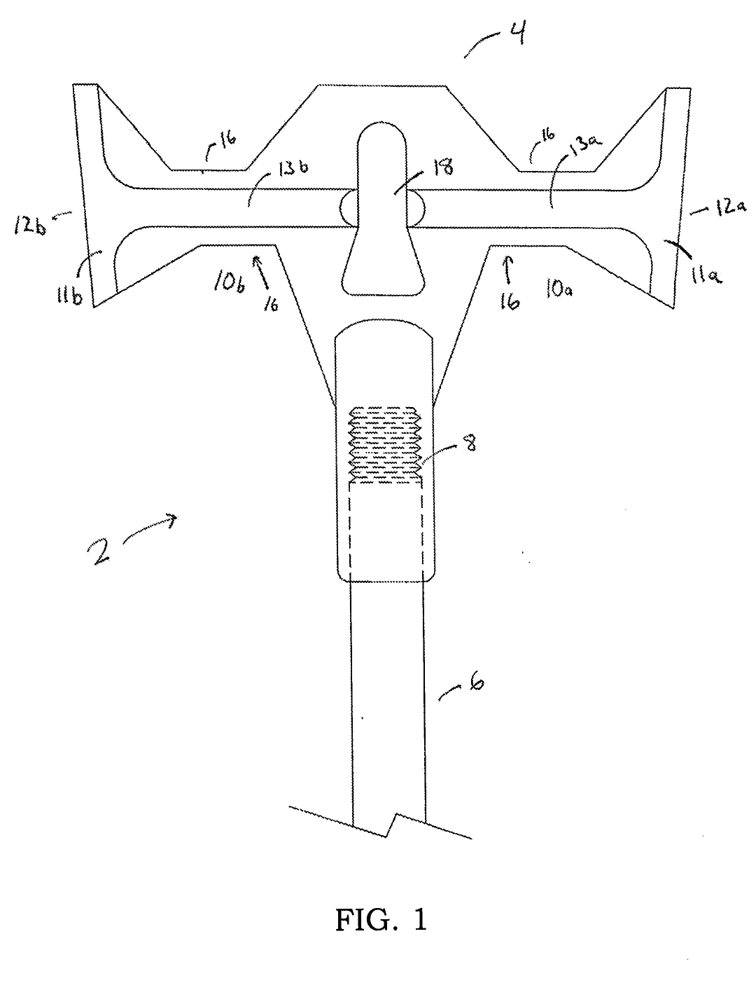

Referring now to the drawings in which like numerals indicate like elements throughout the several views, FIGS. 1-4 depict the present apparatus for a utility tool assembly for use with a handbrake wheel found on most railroad cars and locomotives.

FIG. 1 depicts an embodiment of the present tool 2 for use with railroad cars and locomotives depicting the rigid head 4 attached to the first end 8 of the handle 6 and the opposed first and second hooked portions 10(a-b) extending laterally from the handle 6 and the hooked portions 10(a-b) including each an outer edge head 12(a-b) spaced laterally away from the longitudinal axis of the handle 6. Additionally shown is a concave section 14 extending laterally from the handle 6 to the outer surface 12(a-b), the concave section 14 including a flat portion 16 substantially perpendicular to the longitudinal axis of the handle 6. Further shown is a slot 18 formed within the head 4 having a longitudinal axis substantially aligned with the longitudinal axis of the handle 6. Further shown are the raised rib portions (11 and 13) formed within the rigid head 4.

FIG. 2 illustrates an embodiment of the quick connect/disconnect locking handle mechanism 20 of the present tool 2 for use with railroad cars and locomotives showing the locked position of the locking mechanism 20 locked on the handle 6 of the present tool 2.

FIG. 3 depicts an embodiment of the quick connect/disconnect locking handle mechanism 20 of the present tool 2 for use with railroad cars and locomotives showing the unlocked position of the locking mechanism 20 unlocked on the handle 6 of the present tool 2.

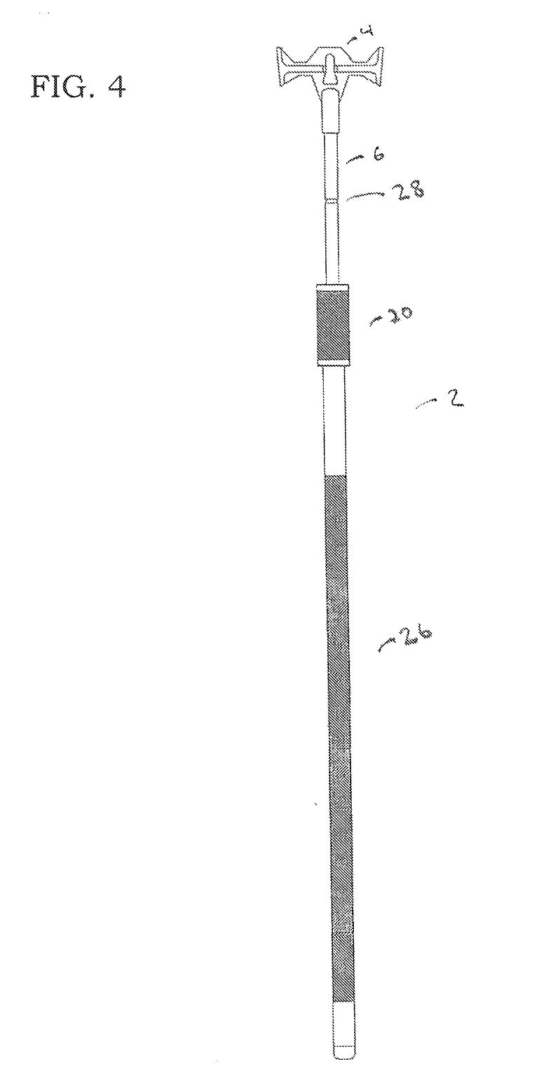

FIG. 4 depicts the overall utility tool 2 wherein the telescoping assembly includes an inner handle section 6 and an outer handle section 26 operatively aligned with the inner handle section 6. The inner handle section 6 includes a series of grooves 28 extending inward from the outer surface at predetermined locations spaced along the length of the inner handle section 6, the grooves 28 defining predetermined locking positions of the inner handle section 6 relative to the outer handle section 28. The outer handle further including a quick connect/disconnect locking handle assembly 20 for engaging the grooves 28 defining the predetermined locking positions.

While Applicant has set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A utility tool for use with railroad cars and locomotives comprising:
an elongated handle having a longitudinal axis and a first and second end;
a rigid head attached to the first end of the handle;
the rigid head including opposed first and second hooked portions extending laterally from the handle;
the first and second hooked portions including each an outer edge head spaced laterally away from the longitudinal axis of the handle;
a concave section extending laterally from the handle to the outer surface;
the concave section including a flat portion substantially perpendicular to the longitudinal axis of the handle;
a slot formed within the head and having a longitudinal axis substantially aligned with the longitudinal axis of the handle.

2. The utility tool of claim 1 wherein the longitudinal axis of the slot includes opposed first and second portions; one of the slot portions is larger and wider than the other whereby the larger and wider portion allows an air brake retainer valve handle or arm to enter into the slotted opening more easily.

3. The utility tool of claim 1, wherein the rigid head includes a raised rib portion(s) extending laterally to the longitudinal axis of the handle.

4. The utility tool of claim 3, wherein the outer edge head portions each further include a raised rib portion for reinforcing the outer edge portions.

5. The utility tool of claim 1, wherein the elongated handle further includes a telescoping assembly whereby the longitudinal axis of the handle can be extended.

6. The utility tool of claim 5, wherein the telescoping assembly includes an inner handle section and an outer handle section operatively aligned with the inner handle section.

7. The utility tool of claim 6, wherein the inner handle section includes a series of grooves extending inward from the outer surface at predetermined locations spaced along the length of the inner handle section, the grooves defining predetermined locking positions of the inner handle section relative to the outer handle section.

8. The utility tool of claim 6, wherein the outer handle further including a quick connect/disconnect locking handle assembly for engaging the grooves defining the predetermined locking positions

9. The utility tool of claim 8, wherein the quick connect/disconnect locking handle assembly is a self-locking and anti-rotational mechanism whereby the handle assembly automatically locks the inner handle section at any one of the predetermined locking positions without the operator having to manually inspect for a secure locked handle.

10. The utility tool of claim 8, wherein the outer handle section includes an outer surface and a series of grooves extending inward from the outer surface forming a knurled pattern whereby forming an easy-to-grip operation for pulling the handle towards an operator when setting the inner handle section to the desired length.

11. A utility tool for use with railroad cars and locomotives comprising:
an elongated handle having a longitudinal axis and a first and second end;
a rigid head attached to the first end of the handle;
a rigid head including opposed first and second hooked portions extending laterally from the handle;
the first and second hooked portions including each an outer edge head portion spaced laterally away from the longitudinal axis of the handle;
a concave section(s) extending laterally from the handle to the outer surface;
the concave section including a flat portion substantially perpendicular to the longitudinal axis of the handle;
a slot formed within the head and having a longitudinal axis substantially aligned with the longitudinal axis of the handle and wherein the longitudinal axis of the slot includes opposed first and second portions, wherein one of the portions is larger and wider than the other whereby the larger portion allows an air brake retainer valve to enter more easily.

12. The utility tool of claim 11, wherein the rigid head includes a raised rib portion extending laterally to the longitudinal axis of the handle.

13. The utility tool of claim 12, wherein the outer edge head portions each further include a raised rib portion for reinforcing the outer edge portions.

14. The utility tool of claim 11, wherein the elongated handle further includes a telescoping assembly comprising an inner handle section and an outer handle section operatively aligned with the inner handle section.

15. The utility tool of claim 14, wherein the inner handle section includes a series of grooves extending inward from the outer surface at predetermined locations along the length of the inner handle section, the grooves defining predetermined locking positions of the inner handle section relative to the outer handle section.

16. The utility tool of claim 14, wherein the outer handle section includes a quick connect/disconnect locking handle assembly for engaging the groves defining the predetermined locking positions, whereby the quick connect/disconnect locking handle assembly is a self-locking, anti-rotational mechanism that automatically and quickly locks the inner handle section at any of the significantly increased number of desired operating lengths without the operator having to manually inspect for a secure locked handle.

17. The utility tool of claim 16, wherein the outer handle section includes an outer surface and a series of grooves extending inward from the outer surface forming a knurled pattern whereby forming an easy-to-grip operation for pulling the handle towards an operator to set the desired length.

18. A utility tool for use with railroad cars and locomotives comprising:
an elongated handle having a longitudinal axis and a first and second end;
a rigid head attached to the first end of the handle, the rigid head including opposed first and second hooked portions extending laterally from the handle and the rigid head having a raised rib portion extending laterally to the longitudinal axis of the handle;
the hooked portions including each an outer edge head portion spaced laterally away from the longitudinal axis of the handle and wherein the outer edge head portions each further include a raised rib portion for reinforcing the outer edge portions;
a concave section extending laterally from the handle to the outer surface, the concave section including a flat portion substantially perpendicular to the longitudinal axis of the handle;
a slot formed within the head and having a longitudinal axis substantially aligned with the longitudinal axis of the handle and wherein the longitudinal axis of the slot includes opposed first and second portions, wherein one of the portions is larger than the other whereby the larger portion allows an air brake retainer valve to enter more easily; and
the elongated handle including a telescoping assembly comprising an inner handle section and an outer handle section operatively aligned with the inner handle section.

19. The utility tool of claim 18, wherein the inner handle section includes a series of grooves extending inward from the outer surface at predetermined locations spaced along the length of the inner handle section, the grooves defining predetermined locking positions of the inner handle section relative to the outer handle section.

20. The utility tool of claim 18, wherein the outer handle further including a quick connect/disconnect locking handle assembly for engaging the grooves defining the predetermined locking positions, whereby the utility tool is a self-locking, anti-rotational mechanism that automatically and quickly locks the tool at any of the significantly increased number of desired operating lengths without the operator having to manually inspect for a secure locked handle.

21. The utility tool of claim 18, wherein the outer handle section includes an outer surface and a series of grooves extending inward from the outer surface forming a knurled pattern whereby forming an easy-to-grip operation for pulling the handle towards an operator to set the desired length.
